(19) United States
(12) Patent Application Publication
(10) Pub. No.: US 2002/0074477 A1
(43) Pub. Date: Jun. 20, 2002

(54) Motor mount

(76) Inventors: James E. Doyle, Grandville, MI (US); Jonathan D. Bruin, Grand Rapids, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/870,091

(22) Filed: May 30, 2001

Related U.S. Application Data
(60) Provisional application No. 60/253,920, filed on Nov. 29, 2000.

(51) Int. Cl. F16M 1/00

(52) U.S. Cl. 248/638

(57) ABSTRACT

A motor assembly for a telescopic leg includes a drive shaft extending therefrom and at least one mounting pin extending from the motor assembly in a direction generally parallel to and spaced from the shaft. A base to which the motor assembly is mounted includes an aperture having a polymeric grommet positioned therein for receiving the pin for providing a noise isolating interconnection of the motor assembly to the base. In a preferred embodiment, a plurality of spaced pins are provided and extend through a plurality of aligned polymeric grommets in the base.

### CROSS-REFERENCE TO RELATED APPLICATIONS

This application claims priority under 35 U.S.C. § 119(e) on U.S. Provisional Application No. 60/253,920 entitled MOTOR MOUNT, filed on Nov. 29, 2000, by James E. Doyle and Jonathan D. Bruin, the entire disclosure of which is incorporated herein by reference.

### BACKGROUND OF THE INVENTION

The present invention relates to a motor mounting assembly for a linear actuator and particularly to one used for actuating telescopic table legs.

Telescopic table legs are commonly used in work places for adjusting the table height for a variety of uses, such as positioning the work surface of a table for standing or various sitting positions. Electrically driven linear actuators are frequently employed to control the height of a table with telescopic legs. Such actuators includes a reversible motor and drive gear assembly coupled to a power screw which extends concentrically within a telescopic leg assembly and couples to a drive nut for extending or retracting one leg with respect to another. Typically, the motor housing is coupled by threaded fasteners to a cap on the top of the inner leg and, as the motor is actuated, the metal-to-metal connection transmits undesirable motor vibration and resonant frequencies through the linear actuator support structure. This noise and vibration is also transmitted through the support structure and legs of the table. Efforts to reduce such noise and vibration in a work place environment have included providing motor mounting pads which extend from a motor housing to a support plate for the motor, however, it remains necessary to prevent shifting of the motor with respect to the driven member during actuation of the motor and a mechanical interconnection is required to prevent movement of the motor drive assembly about the axis of the drive screw when actuated. Thus, a source of transmission of vibration and noise remains with such a system.

### SUMMARY OF THE INVENTION

The system of the present invention overcomes the noise and vibration transmission of the prior art by providing a motor mounting assembly in which a motor includes a motor and gear housing having a drive shaft extending therefrom and at least one mounting pin extending from the motor housing in a direction generally parallel to and spaced from the drive shaft. A base to which the motor is to be mounted includes an aperture having a polymeric grommet positioned therein for receiving the pin of said motor housing and providing a noise isolating interconnection of the motor housing to the base. In a preferred embodiment of the invention, a plurality of spaced pins are provided on the motor or motor housing and extend through a plurality of aligned polymeric grommets in the base.

By providing a pin extending in the direction of the drive screw which is captively received in a grommet, the motor is effectively isolated along two axes, the longitudinal axis of the motor drive shaft and an axis orthogonal thereto by the extension of a pin through a receiving grommet. Accordingly, with the system of the present invention, a noise and vibration isolation motor mount is provided which is relatively easily assembled, inexpensive, and effective in preventing the transmission of noise and vibration from a drive motor in a linear actuator system employed for telescopic legs of a work table.

These and other features, objects and advantages of the present invention will become apparent upon reading the following description thereof together with reference to the accompanying drawings.

### BRIEF DESCRIPTION OF THE DRAWINGS

FIG. 1 is a fragmentary perspective exploded view of a telescopic leg for a table including a motor and base assembly of the present invention;

FIG. 2 is a fragmentary perspective view of the table leg and base coupled thereto;

FIG. 3 is a vertical cross-sectional view of the motor mounting assembly shown in FIGS. 1 and 2; and

FIG. 4 is a vertical cross-sectional view of an alternative embodiment of the present invention.

### DETAILED DESCRIPTION OF THE PREFERRED EMBODIMENT

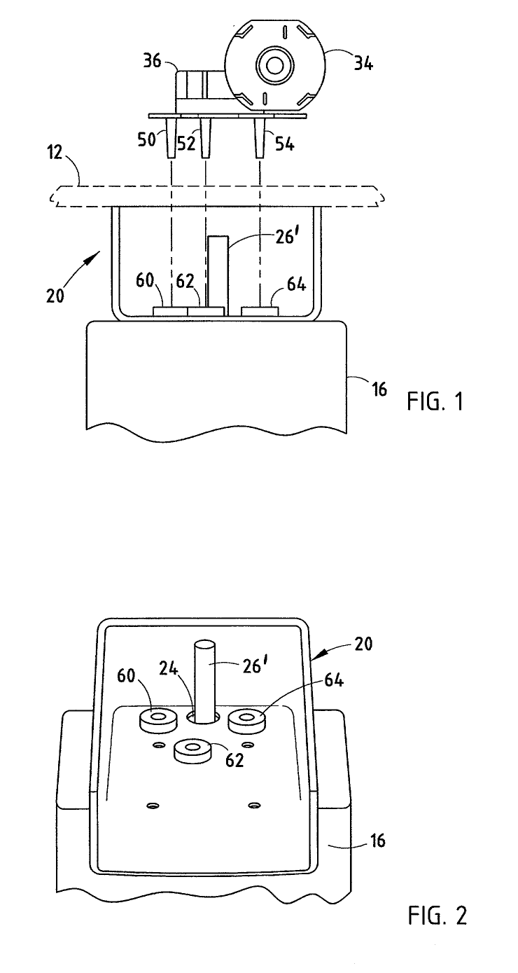

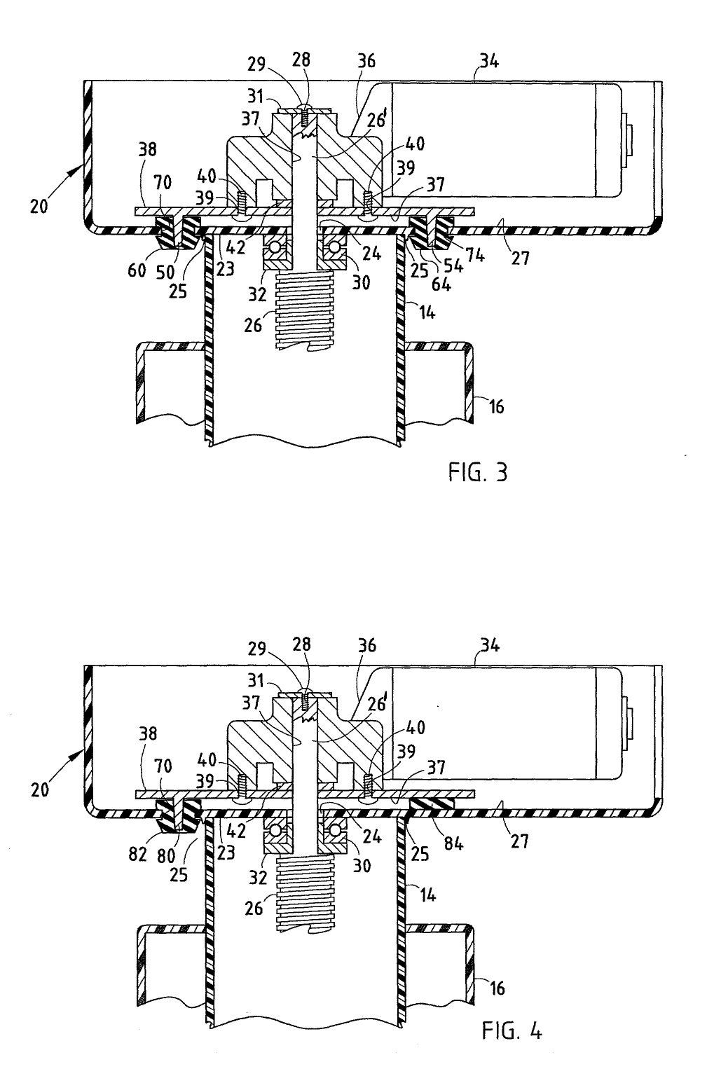

Referring initially to FIG. 1, there is shown a telescopic table leg assembly 10 which is employed to raise and lower a work surface 12, shown schematically in FIG. 1, of a table to be raised and lowered to different use positions. The table leg assembly includes an inner leg 14 and an outer leg 16 (FIG. 3) telescopically receiving the inner leg with an interface cap 15 (FIG. 3) extending along the top of the fixed lower leg 16, which extends to a support surface such as a floor (not shown). Although the invention is described in connection with a two-piece telescopic leg assembly including inner leg 14 and outer leg 16, it is to be understood that other multiple telescopic legs may also incorporate this invention.

The mounting system, as best seen in FIGS. 2 and 3, includes a base 20 having a peripheral flange 22 including apertures 21 (FIG. 2) for securing the base to the undersurface of table 12 as seen in FIG. 1. The base includes a central aperture 24 through which the end 26 of drive screw 26 extends with the lower end of the drive screw being conventionally supported at the lower end in coaxial aligned relationship with legs 14 and 16 through a drive mounted to the outer leg 16 and threadably receiving drive screw 26 such that rotation of the drive screw 26 extends and retracts the inner leg 14 with respect to outer leg 16 in a conventional manner. The drive screw 26 is supported on a lower side 23 of base 20 by means of a thrust bearing 30 (FIG. 3) and washer 32. The lower side 23 of base 20, which is made of stamped steel, is welded to the end of inner leg 14 at junction 25 to fix base 20 to leg 14 with base 20, in turn, fixing leg 14 to table surface 12. The base 20 could also be made from plastic or die cast metal.

A reversible electrical drive motor 34 includes a right angle gear box 36 and motor mounting plate 38 secured to gear box 36 by means of fastening screws 40, which extend through apertures 39 in motor mounting plate 38 into a gear box housing 36. The end 26′ of drive screw 26 includes a threaded aperture 28 for receiving a fastening screw 29. Thus, end 26′ of drive screw 26 is rotatably received in an aperture 37 of gear box housing 36 and is rotatably and vertically held within aperture 37 by fastening screw 29 and washer 31 (FIG. 3). Gear box 36 conventionally includes an internal drive gear (not shown) which engages drive gear 42 fixedly mounted to end 26′ of drive screw 26 for rotating the drive screw 26 in response to actuation of motor 34 in opposite directions for extending and retracting the inner leg 14 with respect to the outer leg 16.

The motor mounting plate 38 includes in a preferred embodiment shown, three equidistant downwardly extending pins 50, 52, and 54 which are axially aligned and spaced from the screw jack end 26 and extend downwardly, as seen in FIGS. 1 and 3, and are received by three equally spaced elastomeric members, such as grommets, 60, 62 and 64 mounted in apertures 70, 72, and 74 formed in surface 23 of base 20 as best seen in FIG. 2. Pins 60, 62, and 64 are preferably tapered at an angle of up to about 10°, as seen in FIG. 3, to readily fit in the apertures of polymeric grommets 60, 62 and 64 for positioning, aligning, and holding the motor mounting plate 38 in alignment with base 20 with the coupling of end 26′ to the gear box 36 securing the motor assembly in a vertical direction, as seen in FIG. 3, with respect to the base 20. Thus, motor 34 is lockably attached to end 26′ of drive screw 26 and its mounting plate 38 is radially fixed with respect to base 22, such that when actuated, the motor torque is transmitted through drive screw 26 and thrust nut 16 and held in position by pins 70, 72, and 74 within grommets 60, 62, and 64 against rotation. The commercially available grommets are typically made of a rubber compound to provide isolation of the motor assembly with respect to base 20 and table legs 14 and 16, thereby greatly reducing the transmission of noise and vibration from the motor to the legs. Although rubber grommets are employed in the embodiment shown, other elastomeric sleeves or grommet-like elements could be employed as long as they receive and locate the pins in base 20 and provide acoustical isolation between the pins and the base.

In an alternative embodiment of the invention as seen in FIG. 4, instead of three equidistant (i.e., 120° spacings) pins, the motor 34 and its plate 38 may include a single pin 80 extending through a grommet 82 in base 20 with sides opposite shaft end 26′ including one or more resilient pads 84 extending between the lower surface 37 of motor mount 38 and the upper surface 27 of base 20. Pin 80 locates and locks motor 34 from rotation as does drive screw 26, while pad(s) 84 also acoustically isolate motor plate 38 form base 20 with the remaining mounting of the motor being identical to that seen in FIGS. 1-3.

In either embodiment, one, two, or three pins can be employed or a combination of one pin and one or more pads 84, as shown in FIG. 4, to provide a stable noise isolation mount for the motor assembly 34 to the telescopic leg assembly. In some embodiments, the mounting pins can be integrally formed on the motor housing or gear box 36 eliminating the necessity of a motor mounting plate. Thus, this invention includes structure in which the interconnection of the motor drive assembly with a telescopic leg includes a pin and an isolating elastomeric grommet-like member.

It will become apparent to those skilled in the art that various modifications to the preferred embodiment of the invention as described herein can be made without departing from the spirit or scope of the invention as defined by the appended claims.

The invention claimed is:

1. A motor mounting system for a telescopic leg assembly comprising:
a motor assembly including a drive shaft extending therefrom for coupling to a drive screw;
at least one pin extending from said motor assembly in a direction generally parallel to and spaced from said drive shaft; and
a base for coupling to a leg of a telescopic leg, said base including an aperture for receiving a drive screw therethrough and an aperture aligned with said pin of said motor assembly, said aperture including an elastomeric element mounted therein for receiving said pin to isolate vibrations from said motor assembly to said base.

2. The motor mounting system of claim 1 wherein said elastomeric element is a grommet.

3. The motor mounting system of claim 2 wherein said pin is tapered to facilitate insertion into said grommet.

4. The motor mounting system of claim 3 wherein said motor assembly includes a plurality of pins and said base includes a plurality of apertures with grommets mounted therein which are aligned with said pins for receiving said pins therein.

5. The motor mounting system of claim 4 where said motor assembly includes three pins and said base includes three apertures with grommets therein.

6. The motor mounting system of claim 5 wherein said motor assembly includes a motor housing having a drive motor and a motor mounting plate and wherein said pins extend from said motor mounting plate.

7. The motor mounting system of claim 6 wherein said pins are angularly generally equally spaced.

8. The motor mounting system of claim 7 wherein said pins are tapered at and angle of up to about 10°.

9. The motor mounting system of claim 8 wherein said grommets are made of rubber.

10. A telescopic leg assembly comprising:
first and second legs telescopically coupled to one another and including a drive screw extending within said legs for extending and retracting one leg from the other leg;
a motor assembly including a drive shaft extending therefrom and coupled to said drive screw;
at least one pin extending from said motor assembly in a direction generally parallel to and spaced from said drive shaft; and
a base coupled to said one telescopic leg, said base including an aperture for receiving s drive screw therethrough and an aperture aligned with said pin of said motor assembly, said aperture including an elastomeric element mounted therein for receiving said pin to isolate vibrations from said motor assembly to said base.

11. The motor mounting system of claim 10 wherein said elastomeric element is a grommet.

12. The motor mounting system of claim 11 wherein said pin is tapered to facilitate insertion into said grommet.

13. The motor mounting system of claim 12 wherein said motor assembly includes a plurality of pins and said base includes a plurality of apertures with grommets mounted therein which are aligned with said pins for receiving said pins therein.

14. The motor mounting system of claim 13 where said motor assembly includes three pins and said base includes three apertures with grommets therein.

15. The motor mounting system of claim 14 wherein said motor assembly includes a motor housing having a drive motor and a motor mounting plate and wherein said pins extend from said motor mounting plate.

16. The motor mounting system of claim 15 wherein said pins are angularly generally equally spaced.

17. The motor mounting system of claim 16 wherein said pins are tapered at and angle of up to about 10°.

18. The motor mounting system of claim 17 wherein said grommets are made of rubber.
